(19) United States
(12) Patent Application Publication
(10) Pub. No.: US 2019/0352961 A1
(43) Pub. Date: Nov. 21, 2019

(54) RETAINER FOR WINDOW BLIND

(71) Applicant: SHEEN WORLD TECHNOLOGY CORPORATION, Taichung City (TW)

(72) Inventors: Hung-Hao CHEN, TAICHUNG CITY (TW); Ming-Che TSAI, TAICHUNG CITY (TW)

(21) Appl. No.: 16/412,698

(22) Filed: May 15, 2019

(30) Foreign Application Priority Data
May 17, 2018 (TW) 107116821

(51) Int. Cl. E06B 9/384; E06B 9/32

(52) U.S. Cl. CPC E06B 9/384; E06B 9/32

(57) ABSTRACT

A retainer includes an abutting portion, a protrusion integrally extended from a side of the abutting portion and having a through hole for a lift pull cord to be slidably threaded therethrough, and two opposite upper cantilever portions and two opposite lower cantilever portions integrally extended from another side of the abutting portion. A first positioning groove is provided between the upper and lower cantilever portions for a slat to be embedded in the first positioning groove. Second and third positioning grooves perpendicularly communicating with the first positioning groove are provided between the upper cantilever portions and between the lower cantilever portions respectively for a tilt cord to be inserted in the second and third positioning grooves.

### BACKGROUND OF THE INVENTION

### 1. Field of the Invention

The present invention relates to window blinds and more particularly, to a retainer for a window.

### 2. Description of the Related Art

Common window blind, such as shutters, structurally includes a top beam, a bottom beam, and a plurality of slats. The slats are parallel suspended between the top and bottom beams by two ladder cords. By being controlled synchronously, the aforesaid two ladder cords can appropriately change the tilt angle of the slats, so that the indoor ambient light can be adjusted at any time.

Referring to FIG. 1, the traditional ladder cord 1 primarily includes two opposite longitudinal strings 2, and many pairs of transverse strings 3 sewed between the two longitudinal strings 2. Every pairs of transverse strings 3 are arranged at intervals along the longitudinal axis of the longitudinal strings 2, primarily for supporting slats 5. Besides, there are many loops 4 sewed on each of the longitudinal strings 2. These loops 4 are arranged at intervals along the longitudinal axis of the longitudinal strings, primarily for lift pull cords 6 to be threaded therethrough. However, in the aforesaid structure, the longitudinal strings 2, the transverse strings 3 and the loops 4 should be connected by a special weaving manner to compose the ladder cord 1 with sufficient strength. Besides, in the process of being combined with the slats 5 and the lift pull cords 6, the transverse strings 3 and the loops 4 are difficult to be fixedly shaped because of the material thereof. Therefore, it usually needs many times of trying at the assembling from different angles and different strength to complete the assembling. In other words, the traditional ladder cord 1 is inconvenient in manufacturing and assembling.

### SUMMARY OF THE INVENTION

It is a primary objective of the present invention to provide a retainer for a window blind, by which a slat, a lift pull cord and a tilt cord can be combined quickly, so that better usage convenience is attained.

To attain the above objective, the retainer of the present invention includes an abutting portion, a protrusion, two upper cantilever portions opposite to each other, and two lower cantilever portions opposite to each other. The protrusion is integrally extended out from a side of the abutting portion and provided with a through hole for the lift pull cord to be slidably threaded through the through hole. The two upper cantilever portions and the two lower cantilever portions are collectively extended out integrally from another side of the abutting portion opposite to the aforesaid side. The two upper cantilever portions being separated from the two lower cantilever portions by a predetermined distance so that a first positioning groove is provided between the two upper cantilever portions for the slat to be embedded in the first positioning groove. A second positioning groove perpendicularly communicating with the first positioning groove is provided between the two upper cantilever portions which are separated from each other by another predetermined distance and a third positioning groove perpendicularly communicating with the first positioning groove is provided between the two lower cantilever portions which are separated from each other by another predetermined distance for the tilt cord to be inserted in the second positioning groove and the third positioning groove.

It can be understood from the above description that the slat, the lift pull cord and the tilt cord can be combined quickly by the retainer of the present invention. Thus, the retainer has the advantages of simple structure and mass production with ease, unlike the traditional ladder cord whose usability should be provided by the special weaving manner. Therefore, better usage convenience is attained.

Preferably, the two upper cantilever portions are provided on the sides thereof facing each other with two second detachment-proof teeth respectively; the two second detachment-proof teeth are located in the first positioning groove and staggered from each other; the two lower cantilever portions are provided on the sides thereof facing each other with two third detachment-proof teeth respectively; the two third detachment-proof teeth are located in the second positioning groove and staggered from each other. In this way, the two first detachment-proof teeth and the two second detachment-proof teeth are adapted for preventing the tilt cord from escaping from the first and second positioning grooves. Furthermore, each of the first detachment-proof teeth and each of the second detachment-proof teeth may have a first guiding slope and a second guiding slope respectively. The two first guiding slopes and the two second guiding slopes are adapted for guiding the tilt cord to pass through the two first detachment-proof teeth and the two second detachment-proof teeth smoothly so as to let the tilt cord inserted and positioned in the second and third positioning grooves.

Further scope of applicability of the retainer of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a partial perspective view of the appearance of the related art.

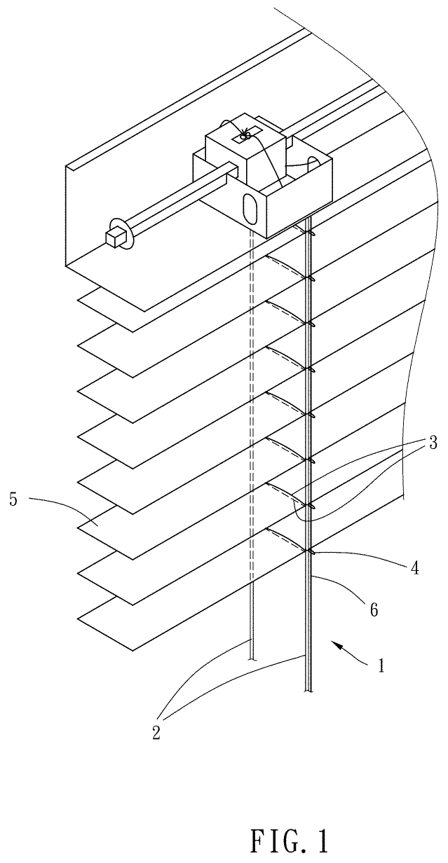

FIG. 2 is a perspective view of the appearance of a retainer of the present invention.

FIG. 3 is a top view of the condition that the retainer of the present invention is in use.

FIG. 4 is a side view of the condition that the retainer of the present invention is in use.

### DETAILED DESCRIPTION OF THE INVENTION

First of all, it is to be mentioned that same reference numerals used in the following preferred embodiments and the appendix drawings designate same or similar elements or features thereof throughout the specification for the purpose of concise illustration of the present invention.

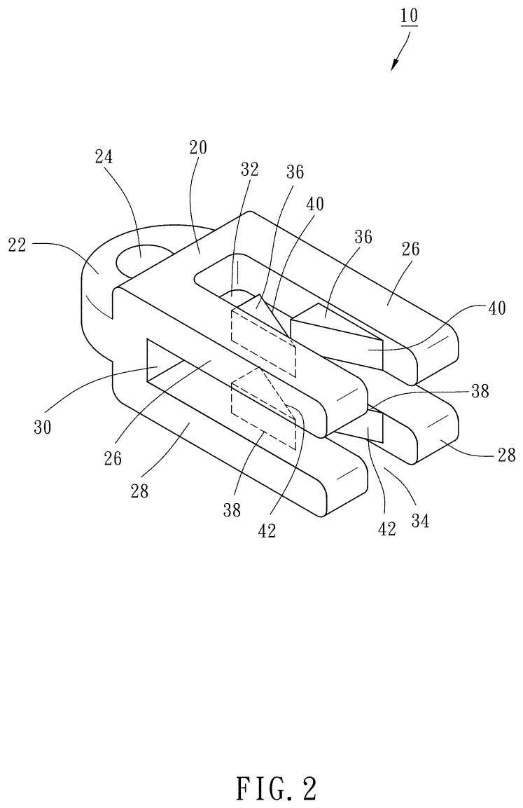

Referring to FIG. 2, the retainer 10 of the present invention includes an abutting portion 20, a protrusion 22, two upper cantilever portions 26 opposite to each other, and two lower cantilever portions 28 opposite to each other.

The protrusion 22 is arc-shaped. The protrusion 22 is integrally extended from a side of the abutting portion 20 and provided with a circular through hole 24.

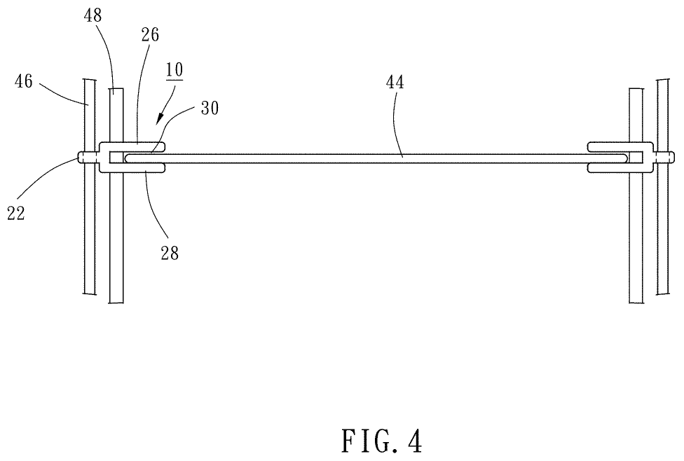

The two upper cantilever portions 26 and the two lower cantilever portions 28 are equal in length. The two upper cantilever portions 26 are integrally extended from the top of a side of the abutting portion 20 opposite to the protrusion 22, and the two lower cantilever portions 28 are integrally extended from the bottom of the side of the abutting portion 20 opposite to the protrusion 22, so that a first positioning groove 30 as shown in FIGS. 2 and 4 is provided between the two upper cantilever portions 26 and the two lower cantilever portions 28. In addition, the two upper cantilever portions 26 are separated from each other by another predetermined distance, so that a second positioning groove 32 perpendicularly communicating with the first positioning groove 30 is provided between the two upper cantilever portions 26. The two lower cantilever portions 28 are also separated from each other by another predetermined distance, so that a third positioning groove 34 perpendicularly communicating with the first positioning groove 30 is provided between the two lower cantilever portions 28. Besides, the two upper cantilever portions 26 are provided on the sides thereof facing each other with two first detachment-proof teeth 36 respectively. The two first detachment-proof teeth 36 are located in the second positioning groove 32 and staggered from each other. The two lower cantilever portions 28 are provided on the sides thereof facing each other with two second detachment-proof teeth 38 respectively. The two second detachment-proof teeth 38 are located in the third positioning groove 34 and staggered from each other. Besides, the two first detachment-proof teeth 36 vertically correspond to the two second detachment-proof teeth 38 respectively. In addition, each of the two first detachment-proof teeth 36 has a first guiding slope 40, and the extension directions of the two first guiding slopes 40 intersect with each other. Each of the two second detachment-proof teeth 38 has a second guiding slope 42, and the extension directions of the two second guiding slopes 42 intersect with each other. Besides, the two first guiding slopes 40 are arranged vertically parallel to the two second guiding slopes 42.

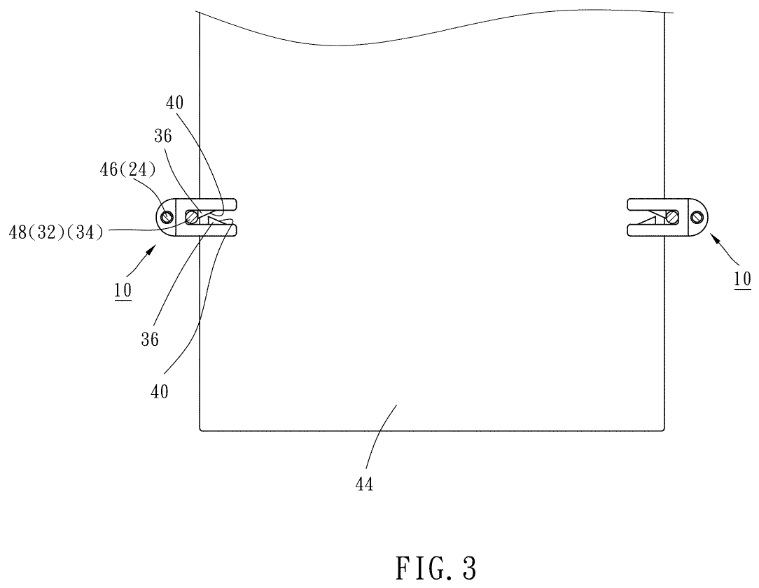

In practical use, the retainer 10 of the present invention is disposed correspondingly to the positions of a lift pull cord 46 and a tilt cord 48. In general, a window blind has a plurality of slats 44 (unlimited in amount) arranged at intervals from the top to the bottom of the window blind, many pairs of lift pull cords 46 (unlimited in amount), and many pairs of tilt cords 48 (unlimited in amount). The lift pull cords 46 are adapted to pull a bottom beam (not shown) to cause the slats 44 folded up by the upwardly moving bottom beam. The tilt cords 48 are adapted to change the deflection angle of the slats 44, thereby attaining the effect of adjusting the indoor ambient light. For the convenience of illustration, FIGS. 3 and 4 only show an end of a slat 44, two lift pull cords 46 and two tilt cords 48.

During the assembling, the lift pull cord 46 is threaded through the through hole 24 of the protrusion 22 of the retainer 10, and the inner radius of the through hole 24 is slightly larger than the outer radius of the lift pull cord 46 so that the lift pull cord 46 is vertically slidable in the through hole 24 when receiving a pulling force. In this way, the lift pull cord 46 is prevented from interfering with the retainer 10 during the operation. Besides, the long side of the slat 44 is embedded in the first positioning groove 30 of the retainer 10, and the tilt cord 48 is inserted in the second and third positioning grooves 32 and 34 of the retainer 10. Specifically speaking, the first and second guiding slopes 40 and 42 of the first and second detachment-proof teeth 36 and 38 of the retainer 10 let the tilt cord 48 pass through the first and second detachment-proof teeth 36 and 38 smoothly, so as to let the tilt cord 48 inserted in the second and third positioning grooves 32 and 34 of the retainer 10 in a tight fit manner. After the positioning is accomplished, the first and second detachment-proof teeth 36 and 38 of the retainer 10 can prevent the tilt cord 48 from escaping from the second and third positioning grooves 32 and 34 of the retainer 10. In this way, when receiving the pulling force, the tilt cord 48 can drive the retainer 10 to operate together, causing the retainer 10 to change the tilt angle of the slat 44.

It should be additionally mentioned here that the first and second detachment-proof teeth 36 and 38 are not necessarily used at the same time. In other words, the retainer 10 of the present invention may he alternatively only provided with the two first detachment-proof teeth 36 on the two upper cantilever portions 26 (i.e. no second detachment-proof teeth 38) or only provided with the two second detachment-proof teeth 38 on the two lower cantilever portions 28 (i.e. no first detachment-proof teeth 36). The detachment-proof effect for the tilt cord 48 can be performed only by the first detachment-proof teeth 36 or the second detachment-proof teeth 38, but the retainer 10 having both of them can certainly provide relatively better effect.

It can be understood from the above illustration that the slat 44, the lift pull cord 46 and the tilt cord 48 can be combined quickly by the retainer 10 of the present invention, and the retainer 10 has the advantages of simple structure and mass production with ease, unlike the traditional ladder cord 1 whose usability should be provided by the special weaving manner. Besides, the traditional ladder cord 1 is relatively more inconvenient for assembling when the traditional ladder cord 1 is sleeved onto the slat 5 or when the lift pull cord 6 is threaded through the traditional ladder cord 1, for example. Therefore, the retainer 10 of the present invention can certainly attain the objective of increasing the usage convenience.

What is claimed is:

1. A retainer for a window blind, which is adapted to connect a slat, a lift pull cord and a tilt cord, the retainer comprising an abutting portion, a protrusion being integrally extended from a side of the abutting portion and provided with a through hole for the lift pull cord to be slidably threaded through the through hole, two upper cantilever portions opposite to each other and two lower cantilever portions opposite to each other being integrally extended from another side of the abutting portion opposite to the aforesaid side, the two upper cantilever portions being separated from the two lower cantilever portions by a predetermined distance so that a first positioning groove is provided between the two upper cantilever portions for the slat to be embedded in the first positioning groove, a second positioning groove perpendicularly communicating with the first positioning groove being provided between the two upper cantilever portions which are separated from each other by another predetermined distance and a third positioning groove perpendicularly communicating with the first positioning groove being provided between the two lower cantilever portions which are separated from each other by another predetermined distance for the tilt cord to be inserted in the second positioning groove and the third positioning groove.

2. The retainer as claimed in claim 1, wherein the two upper cantilever portions are provided on sides thereof facing each other with two first detachment-proof teeth respectively; the two first detachment-proof teeth are located in the second positioning groove and staggered from each other.

3. The retainer as claimed in claim 2, wherein each of the first detachment-proof teeth of the two upper cantilever portions has a first guiding slope; extension directions of the two first guiding slopes intersect with each other.

4. The retainer as claimed in claim 1, wherein the two lower cantilever portions are provided on sides thereof facing each other with two second detachment-proof teeth respectively; the two second detachment-proof teeth are located in the third positioning groove and staggered from each other.

5. The retainer as claimed in claim 4, wherein each of the second detachment-proof teeth of the two lower cantilever portions has a second guiding slope; extension directions of the two second guiding slopes intersect with each other.

6. The retainer as claimed in claim 1, wherein the two upper cantilever portions are provided on sides thereof facing each other with two first detachment-proof teeth respectively; the two first detachment-proof teeth are located in the second positioning groove and staggered from each other; the two lower cantilever portions are provided on sides thereof facing each other with two second detachment-proof teeth respectively; the two second detachment-proof teeth are located in the third positioning groove and staggered from each other; the two first detachment-proof teeth vertically correspond to the two second detachment-proof teeth.

7. The retainer as claimed in claim 6, wherein each of the first detachment-proof teeth of the two upper cantilever portions has a first guiding slope; extension directions of the two first guiding slopes intersect with each other; each of the second detachment-proof teeth of the two lower cantilever portions has a second guiding slope; extension directions of the two second guiding slopes intersect with each other.

8. The retainer as claimed in claim 1, wherein the two upper cantilever portions and the two lower cantilever portions are equal in length.
